(19) United States
(12) Patent Application Publication
(10) Pub. No.: US 2015/0065659 A1
(43) Pub. Date: Mar. 5, 2015

(54) POLYMERIC STRUCTURE

(71) Applicants: Wayne Christopher Edward SCHOFIELD, Durham (GB); Suzanne MORSCH, Woodthorpe (GB); Jas Pal Singh BADYAL, Wolsingham (GB)

(72) Inventors: Wayne Christopher Edward SCHOFIELD, Durham (GB); Suzanne MORSCH, Woodthorpe (GB); Jas Pal Singh BADYAL, Wolsingham (GB)

(21) Appl. No.: 14/490,269

(22) Filed: Sep. 18, 2014

Related U.S. Application Data
(63) Continuation of application No. 14/233,246, now abandoned.

(30) Foreign Application Priority Data
Jul. 19, 2011 (GB) 1112369.2

(51) Int. Cl. C08F 293/00

(52) U.S. Cl. CPC C08F 293/005
USPC 525/286; 525/291

(57) ABSTRACT

The invention features a method of creating a polymer brush bearing covalently bound polymeric side chains, comprising the steps of: (a) deposition, onto a substrate, of a halogen containing initiator film or a precursor which is derivatized into a halogen containing initiator film; (b) surface ATRP growth, from the halogen containing initiator film formed in step (a), of a polymeric brush backbone incorporating side groups; (c) growth, from the polymeric brush backbone formed in step (b), of polymeric side chains on the polymeric brush backbone, to form a polymer brush in which the polymeric side chains constitute the bristles of the brush.

### FIELD OF THE INVENTION

The present invention relates to a method of creating a polymer brush bearing covalently bound polymeric side chains, a polymer brush formed by the method, and use of the polymer brush as a lubricant.

### BACKGROUND TO THE INVENTION

Well-defined linear polymer brushes bearing a large number of covalently bound polymer side chains are commonly referred to as molecular bottle brushes. These have attracted significant attention in view of their novel properties which include stimuli-responsive action and supersoft rheological behaviour for potential applications such as sensors, nanoscopic templates, photonic crystals, and molecular tensile machines. Furthermore, bottle brush polymers dispersed in solution followed by surface adsorption have been shown to display extremely low nanofriction behaviour attributable to intra- and intermolecular repulsion between the densely crowded bristle segments. Based upon this premise, covalent tethering of well-defined polymer bottle brushes to solid surfaces would be expected to confer improved nanolubricity as a consequence of exacerbated steric crowding.

There exist three distinct methodologies for the synthesis of molecular bottle brushes. Firstly there are ‘grafting to’ approaches which entail coupling pre-formed macromolecular side chains to polymeric backbones. These suffer from an inherently limited density of side chain attachment, owing to steric constraints. Secondly, there are ‘grafting through’ methods which comprise the polymerization of macromonomers (pre-formed oligomers bearing a polymerizable group and a side chain already intact) but these tend to undergo a loss of polymerization control with increasing side chain length leading to poor polydispersity. Finally, there are ‘grafting from’ methods which involve controlled polymerization of side chains from initiation sites located along the length of a well defined polymer backbone. For this case, intrinsic control is achievable over both backbone and side chain sizes, leading to the synthesis of complex bottle brush structures. However in such cases, studies have focused on the solution phase synthesis followed by surface adsorption rather than targeting surface tethering of the polymer bottle brushes.

Atom transfer radical polymerization (ATRP) is widely used for controlled/living polymerization because of the mild reaction conditions involved and applicability to a wide range of monomer functionalities. This technique is frequently adapted for the synthesis of well defined co-polymers, for instance the formation of block co-polymers using successive ATRP polymerizations in conjunction with the serial reactivation of ‘living’ halide capped chain ends. Another variant comprises well-defined linear polymer brushes bearing a large number of covalently bound polymer side chains which are referred to as molecular bottle brushes. ATRP initiated from surface sites is well documented for producing densely grafted polymer/copolymer brush layers. However, the grafting from approach for attaching polymer bottle brushes onto surfaces is more challenging due to the inherent steric crowding of the backbone polymers, which hinder the growth of side chains (bristles). Such steric crowding is symptomatic of densely packed ATRP initiation sites prepared using self-assembled monolayers (SAMs). Previous attempts aimed at surface functionalisation with bottle brushes have been limited to using grafting through methods yielding poorly defined bristles or alternatively, just physisorption of pre-formed bottle brushes from solution. There has also been an earlier attempt to employ the grafting from approach utilising successive surface initiated ATRP polymerizations of the backbone and then side chain segments by using mixed SAMs to lower initiator density at the substrate surface (to provide sufficient spacing between grafts for the subsequent growth of side chains); however, no conclusive evidence was presented for the tethering of well defined bottle brushes to the surface. Furthermore, there exist inherent disadvantages associated with SAMs which include long term instability towards oxidation in the case of thiol—gold systems, moisture sensitivity of silanes, and the requirement for multiple step syntheses to prepare appropriate SAM initiator molecules.

All of the aforementioned drawbacks can potentially be overcome by plasmachemical deposition to create ATRP initiator layers in a single step. For example, Teare, D. O. H.; Barwick, D. C.; Schofield, W. C. E.; Garrod, R. P.; Ward, L. J.; Badyal, J. P. S. Langmuir 2005, 21, 11425 discloses that pulsed plasma deposited poly(vinylbenzyl chloride) initiator layers have been successfully employed for the ATRP growth of well-defined polymer brushes onto a variety of solid substrates. This approach ensures covalent attachment to the substrate via reactive sites created at the interface by the electrical discharge during the onset of nanolayer deposition (for silicon and glass substrates, Si—C bonds will be responsible for adhesion, similarly M-C bonds for metals, whilst for polymers it is free radicals created by the electrical discharge). Moreover, the density of functional groups presented at the surface can be customized by careful tuning of the electrical discharge parameters.

Plasma deposition techniques have been quite widely used for the deposition of polymeric coatings onto a range of surfaces. This technique is recognised as being a clean, dry technique that generates little waste compared to conventional wet chemical methods. Using this method, plasmas are generated from organic molecules, which are subjected to an electrical field. When this is done in the presence of a substrate, the radicals of the compound in the plasma polymerize on the substrate. Conventional polymer synthesis tends to produce structures containing repeat units that bear a strong resemblance to the monomer species, whereas a polymer network generated using a plasma can be extremely complex. The properties of the resultant coating can depend upon the nature of the substrate as well as the nature of the monomer used and conditions under which it is deposited. A method of plasma polymerization to create water and oil repellent surfaces is disclosed in international patent application WO 98/58117.

### STATEMENTS OF THE INVENTION

A first aspect of the present invention provides a method of creating a polymer brush bearing covalently bound polymeric side chains, comprising the steps of:
(a) deposition, onto a substrate, of a halogen containing initiator film or a precursor which is derivatized into a halogen containing initiator film;
(b) surface ATRP growth, from the halogen containing initiator film formed in step (a), of a polymeric brush backbone incorporating side groups;
(c) growth, from the polymeric brush backbone formed in step (b), of polymeric side chains on the polymeric brush backbone, to form a polymer brush in which the polymeric side chains constitute the bristles of the brush.

Throughout this specification, the term “polymer” includes homopolymers and co-polymers.

In an embodiment, the polymer brush comprises a polymer bottle brush, which can, for example, be a polymer nano bottle brush.

In an embodiment, the side groups on the polymeric brush backbone formed in step (b) comprise further initiation sites for polymer growth.

In an embodiment, in step (c), the growth of polymeric side chains on the polymeric brush backbone occurs via one or more derivatization steps in which the side groups on the polymeric brush backbone are derivatized to form further initiation sites for polymer growth.

In an embodiment, the halogen containing initiator film is formed by polymerization, resulting in a polymeric halogen containing initiator film.

In an embodiment, the halogen containing initiator film is formed by polymerization of a halogen containing molecule. In an embodiment, the halogen containing molecule is a vinylbenzyl halide. In an embodiment, the vinylbenzyl halide is vinylbenzyl chloride.

In an embodiment, the deposition of the halogen containing initiator film or the precursor is by a technique selected from the group of plasma polymerization, thermal chemical vapour deposition, initiated chemical vapour deposition (iCVD), photodeposition, ion-assisted deposition, electron beam polymerization, gamma-ray polymerization, target spluttering, and any combination thereof.

In an embodiment, the halogen containing initiator film is deposited by plasma polymerization. In this embodiment, one or more of the following conditions may be used:
a. a pressure of from 0.01 mbar to 1 bar, for example from 0.01 or 0.1 mbar to 1 mbar or from 0.1 to 0.5 mbar, such as about 0.2 mbar.
b. a temperature of from 0 to 300° C., for example from 10 or 15 to 70° C. or from 15 to 30° C., such as room temperature (which may be from about 18 to 25° C., such as about 20° C.)
c. a power (or in the case of a pulsed plasma, a peak power) of at least 0.1 W, or at least 1 W, or at least 5 W, or at least 10 W, or at least 20 W; and/or of up to 40 W, or up to 50 W, or up to 60 W, or up to 70 W, or up to 100 W, or up to 500 W; such as for example from 0.1 to 500 W, or from 0.1 to 100 W, or from 5 to 70 W or from 5 or 10 to 50 or 60 W, or from 20 to 40 W, such as about 30 W.
d. in the case of a pulsed plasma, a duty cycle on-period of from 1 μs to 5 ms, for example from 1 to 500 μs or from 1 to 200 μs or from 50 to 200 μs, such as about 100 μs.
e. in the case of a pulsed plasma, a duty cycle off-period of from 1 μs to 500 ms, for example from 1 to 250 ms or from 1 to 100 ms or from 1 to 10 ms, such as about 4 ms.
f. in the case of a pulsed plasma, a ratio of duty cycle on-period to off-period of from 1×10⁻⁵ to 1.0, or from 0.001 to 0.1, for example from 0.001 to 0.05 or from 0.01 to 0.05 or from 0.01 to 0.04, such as about 0.025.

In an embodiment, the plasma polymerization is pulsed plasma polymerization.

In an embodiment, the plasma polymerization is continuous wave (CW) plasma polymerization.

In an embodiment, the plasma contains one or more monomeric compounds suitable for forming the halogen containing initiator film. In an embodiment, the plasma contains a single monomeric compound suitable for forming the halogen containing initiator film. In an alternative embodiment, the plasma contains a mixture of different monomeric compounds suitable for forming the halogen containing initiator film.

In an embodiment, the plasma further contains an inert carrier gas. In an embodiment, the inert carrier gas is helium or argon.

The deposition of the halogen containing initiator film in step (a) on a substrate can comprise partial or complete coverage of the substrate. In an embodiment, in step (a), the halogen containing initiator film is deposited on part of the substrate. In an embodiment, in step (a), the halogen containing initiator film is deposited on the substrate in the form of a pattern. Such a pattern can, for example, be formed by using a mask as a template for the pattern.

In an embodiment, in step (b), the monomer used for the surface ATRP growth of the polymeric brush backbone is selected from the group of styrenes, acrylates, methacrylates, and acrylonitrile. In an embodiment, the monomer comprises glycidyl methacrylate.

In an embodiment, in step (c), the growth of polymeric side chains on the polymeric brush backbone occurs via controlled graft polymerization.

In an embodiment, in step (c), the growth of polymeric side chains on the polymeric brush backbone is ATRP growth.

In an embodiment, in step (c), the side groups on the polymeric brush backbone are derivatized to form ATRP initiation sites for ATRP growth of the polymeric side chains.

In an embodiment, the side groups on the polymeric brush backbone are derivatized to form halogenated ATRP initiation sites.

In an embodiment the side groups on the polymeric brush backbone are derivatized by reaction with bromoacetic acid.

In an embodiment, in step (c), the monomer used for the growth of the polymeric side chains is selected from the group of styrenes, acrylates, methacrylates, and acrylonitrile. In an embodiment, the monomer comprises sodium styrene sulfonate.

In an embodiment, the bristles of the polymer brush formed in step (c) are formed by poly(sodium styrene sulfonate) side chains.

In an embodiment, the polymer brush formed in step (c) is a polyelectrolyte brush.

In an embodiment, the substrate in step (a) is selected from the group of glass, metal, silicon, woven or non-woven fibres, natural fibres, synthetic fibres, ceramics, semiconductors, cellulosic materials, paper, wood, and polymers such as, for example, polytetrafluoroethylene, polyethylene or polystyrene.

A second aspect of the present invention provides a polymer brush formed by the method of the first aspect.

In an embodiment, step (b) of the method has resulted in an ATRP grafted layer on the substrate which layer has an average thickness of less than 10 microns.

In an embodiment, the polymer brush is formed by the method wherein in step (b), the monomer used for the surface ATRP growth of the polymeric brush backbone comprises glycidyl methacrylate and the ATRP grafted layer is a poly(glycidyl methacrylate) layer.

A third aspect of the present invention provides a use of a polymer brush according to the second aspect as a lubricant.

In the present invention, surface tethered polymer brushes have been prepared by ATRP grafting of the macroinitiator polymeric brush backbone onto plasmachemically deposited poly(vinylbenzyl chloride) initiator nanofilms followed by ATRP growth of the polymeric side chains (bristles). The surface density of polymer brushes can be precisely tailored by varying the plasmachemical deposition parameters employed for making the poly(vinylbenzyl chloride) initiator nanofilms. Lateral force scanning probe microscopy has shown that polymer brush decorated surfaces lead to an enhancement in nanolubrication.

A fourth aspect of the present invention provides a method of creating an initiator film for subsequent ATRP growth of a polymer brush, the method comprising deposition of a halogen containing initiator film or a precursor which is derivatized into a halogen containing initiator film onto a substrate by continuous wave plasma polymerization.

In the methods of the first and fourth aspect of the invention, the halogen containing initiator film is formed by polymerization of formula M-X, where M is a polymerizable group and X is a halogen atom.

In one embodiment, the halogen containing initiator film is formed by polymerization of a halogen containing molecule. In an embodiment, the halogen containing molecule is a vinylbenzyl halide. In an embodiment, the vinylbenzyl halide is vinylbenzyl chloride.

Plasma polymers are typically generated by subjecting a coating forming precursor to an ionising electric field under low pressure conditions. Deposition occurs when excited species generated by the action of the electric field upon the precursor (radicals, ions, excited molecules etc) polymerize in the gas phase and react with the substrate surface to form a growing polymer film.

Precise conditions under which either pulsed or continuous wave plasma deposition of the initiator films takes place in an effective manner will vary depending upon factors such as the nature of the monomer, the substrate, the size and architecture of the plasma deposition chamber etc and will be determined using routine methods and/or the techniques.

Suitable plasmas for use in the methods described herein include non-equilibrium plasmas such as those generated by radiofrequencies (RF), microwaves or direct current (DC). They may operate at atmospheric or sub-atmospheric pressures as are known in the art. In particular however, they are generated by radiofrequencies (RF).

Various forms of equipment may be used to generate gaseous plasmas. Generally these comprise containers or plasma chambers in which plasmas may be generated. Particular examples of such equipment are described for instance in WO 2005/089961 and WO02/28548, but many other conventional plasma generating apparatus are available.

In general, the item to be treated is placed within a plasma chamber together with the material to be deposited in gaseous state, a glow discharge is ignited within the chamber and a suitable voltage is applied.

The gas used within the plasma may comprise a vapour of the monomeric compound alone, but it may be combined with a carrier gas, in particular an inert gas such as helium or argon. In particular helium is a preferred carrier gas as this can minimises fragmentation of the monomer.

When used as a mixture, the relative amount of the monomer vapour to carrier gas is suitably determined in accordance with procedures which are conventional in the art. The amount of monomer added will depend to some extent on the nature of the particular monomer being used, the nature of the substrate being treated, the size of the plasma chamber etc. Generally, in the case of conventional chambers, monomer is delivered in an amount of from 50-250 mg/min, for example at a rate of from 100-150 mg/min. Carrier gas such as helium is suitably administered at a constant rate for example at a rate of from 5-90, for example from 15-30 sccm. In some instances, the ratio of monomer to carrier gas will be in the range of from 100:1 to 1:100, for instance in the range of from 10:1 to 1:100, and in particular about 1:1 to 1:10. The precise ratio selected will be so as to ensure that the flow rate required by the process is achieved.

In some cases, a preliminary continuous power plasma may be struck, for example for from 2-10 minutes such as for about 4 minutes, within the chamber. This may act as a surface pre-treatment step, ensuring that the monomer attaches itself readily to the surface, so that as polymerization occurs, the coating “grows” on the surface. The pre-treatment step may be conducted before monomer is introduced into the chamber, in the presence of only the inert gas.

A glow discharge is suitably ignited by applying a high frequency voltage, for example at 13.56 MHz. This is suitably applied using electrodes, which may be internal or external to the chamber, but in the case of the larger chambers are internal.

Suitably the gas, vapour or gas mixture is supplied at a rate of at least 1 standard cubic centimetre per minute (sccm) and preferably in the range of from 1 to 100 sccm.

In the case of the monomer vapour, this is suitably supplied at a rate of from 80-300 mg/minute, for example at about 120 mg per minute depending upon the nature of the monomer, whilst the voltage is applied.

Gases or vapours may be drawn or pumped into the plasma region. In particular, where a plasma chamber is used, gases or vapours may be drawn into the chamber as a result of a reduction in the pressure within the chamber, caused by use of an evacuating pump, or they may be pumped or injected into the chamber as is common in liquid handling.

Polymerization is suitably effected using vapours of initiator film precursor, which are maintained at pressures of from 0.1 to 200 mtorr, suitably at about 80-100 mtorr.

The applied fields are suitably of a power (or in the case of a pulsed plasma, a peak power) of at least 0.1 W, or at least 1 W, or at least 5 W, or at least 10 W, or at least 20 W; and/or of up to 40 W, or up to 50 W, or up to 60 W, or up to 70 W, or up to 100 W, or up to 500 W; such as for example from 0.1 to 500 W, or from 0.1 to 100 W, or from 5 to 70 W or from 5 or 10 to 50 or 60 W, or from 20 to 40 W, such as about 30 W.

The fields are suitably applied from 30 seconds to 90 minutes, preferably from 5 to 60 minutes, depending upon the nature of the precursor and the item being treated etc.

Suitably a plasma chamber used is of sufficient volume to accommodate multiple items.

A particularly suitable apparatus and method for producing items in accordance with the invention is described in WO 2005/089961.

These conditions are particularly suitable for depositing good quality uniform coatings, in large chambers, for example in chambers where the plasma zone has a volume of greater than 500 cm³, for instance 0.5 m³ or more, such as from 0.5 m³-10 m³ and suitably at about 1 m³. The layers formed in this way have good mechanical strength.

The dimensions of the chamber will be selected so as to accommodate the particular item being treated. For instance, generally cuboid chambers may be suitable for a wide range of applications, but if necessary, elongate or rectangular chambers may be constructed or indeed cylindrical, or of any other suitable shape.

The chamber may be a sealable container, to allow for batch processes, or it may comprise inlets and outlets for the items, material or yarn, to allow it to be utilised in a continuous process. In particular in the latter case, the pressure conditions necessary for creating a plasma discharge within the chamber are maintained using high volume pumps, as is conventional for example in a device with a “whistling leak”. However it will also be possible to process certain items at atmospheric pressure, or close to, negating the need for “whistling leaks”.

This method is suitable for a wide range of substrates. For example, the substrate may be selected from the group of glass, metal, silicon, woven or non-woven fibres, natural fibres, synthetic fibres, ceramics, semiconductors, cellulosic materials, paper, wood, and polymers such as, for example, polytetrafluoroethylene, polyethylene or polystyrene.

Preferred features of each aspect of the invention may be as described in connection with any of the other aspects. For example, preferred features of the second, third, and fourth aspects of the invention may be as described above in connection with the first aspect and vice versa.

Throughout the description and claims of this specification, the words “comprise” and “contain” and variations of the words, for example “comprising” and “comprises”, mean “including but not limited to”, and do not exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Other features of the present invention will become apparent from the following example. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith.

Moreover unless stated otherwise, any feature disclosed herein may be replaced by an alternative feature serving the same or a similar purpose.

In this specification, references to compound properties are—unless stated otherwise—to properties measured under ambient conditions, i.e. at atmospheric pressure and at a temperature of from 16 to 22 or 25° C., or from 18 to 22 or 25° C., for example about 20° C. or about 25° C.

The present invention will now be described by way of example only and with reference to the accompanying illustrative drawings, in which:

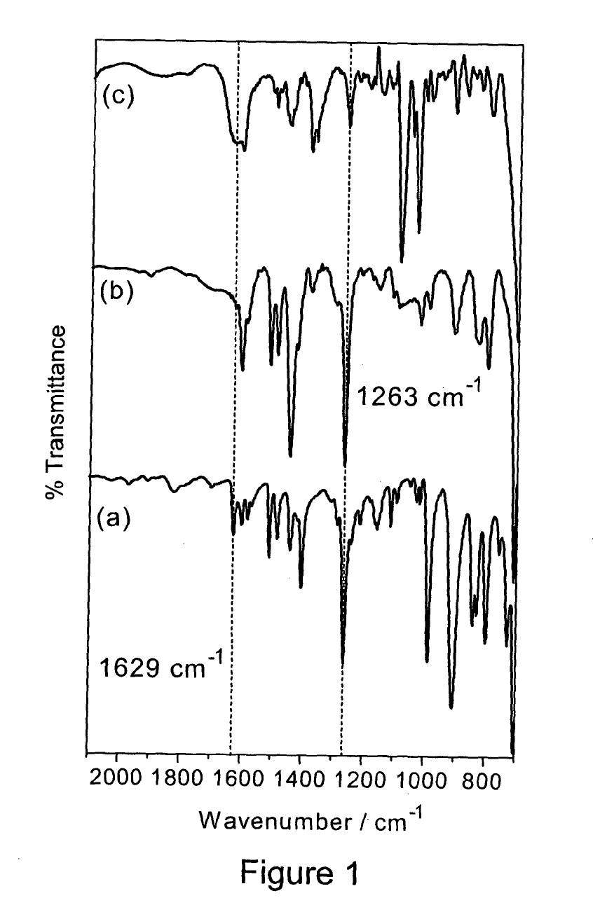

FIG. 1 shows infrared spectra of: (a) vinylbenzyl chloride monomer; (b) pulsed plasma deposited poly(vinylbenzyl chloride) film; and (c) continuous wave plasma deposited poly(vinylbenzyl chloride) film;

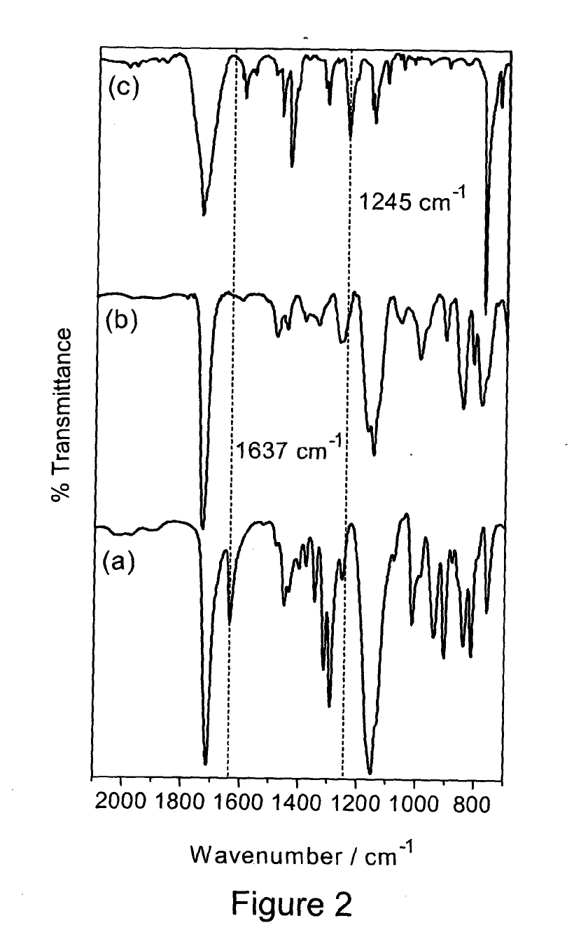

FIG. 2 shows infrared spectra of: (a) glycidyl methacrylate monomer; (b) ATRP grafted poly(glycidyl methacrylate) grown from pulsed plasma deposited poly(vinylbenzyl chloride) initiator film; and (c) following 4 hr exposure of (b) to bromoacetic acid at 75° C.;

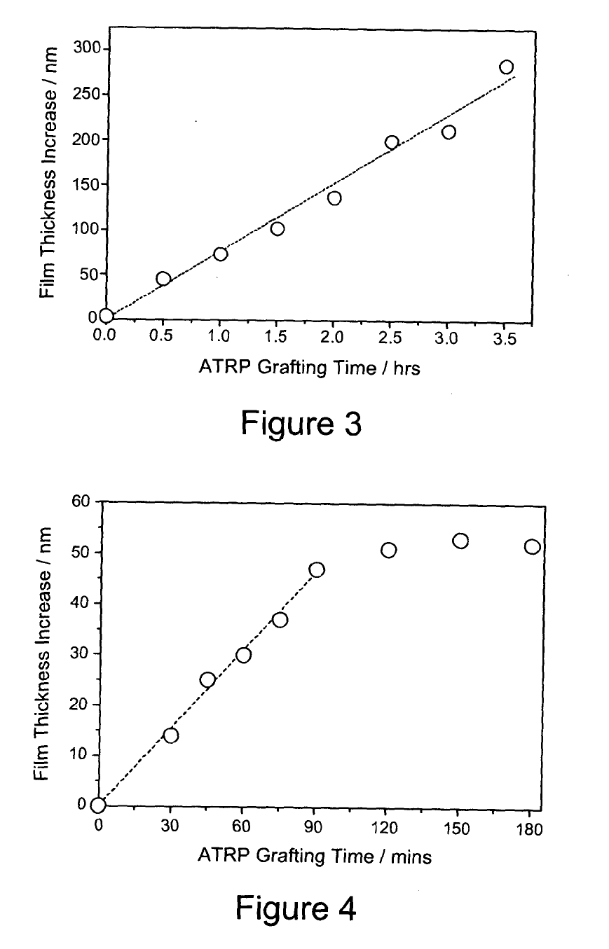

FIG. 3 shows variation of poly(glycidyl methacrylate) film thickness as a function of ATRP grafting time onto pulsed plasma deposited poly(vinylbenzyl chloride) initiator film;

FIG. 4 shows poly(sodium styrene sulfonate) film thickness as a function of ATRP grafting time onto pulsed plasma deposited poly(vinylbenzyl chloride) initiator film;

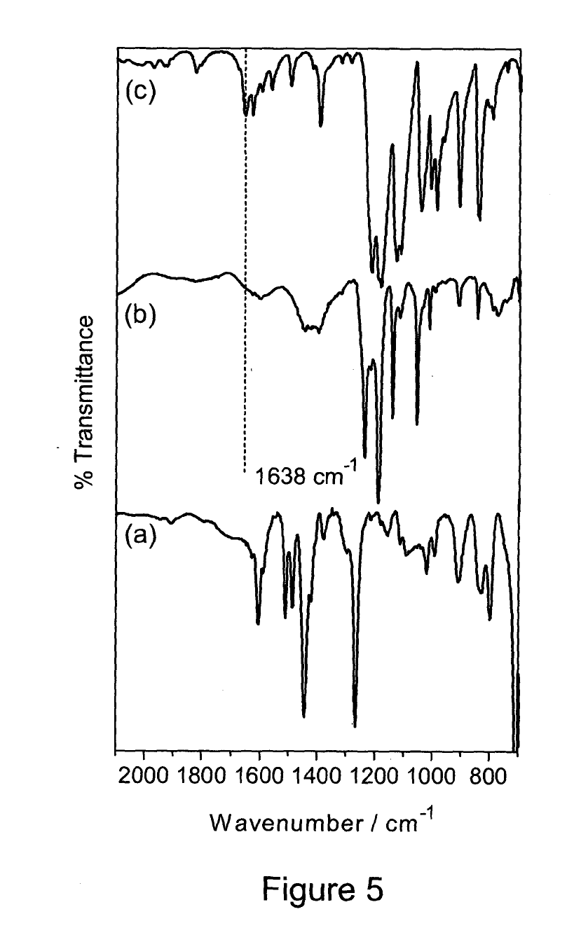

FIG. 5 shows infrared spectra of: (a) pulsed plasma deposited poly(vinylbenzyl chloride) ATRP initiator film; (b) ATRP grafted poly(sodium styrene sulfonate) onto pulsed plasma deposited poly(vinylbenzyl chloride) initiator film; and (c) sodium styrene sulfonate monomer;

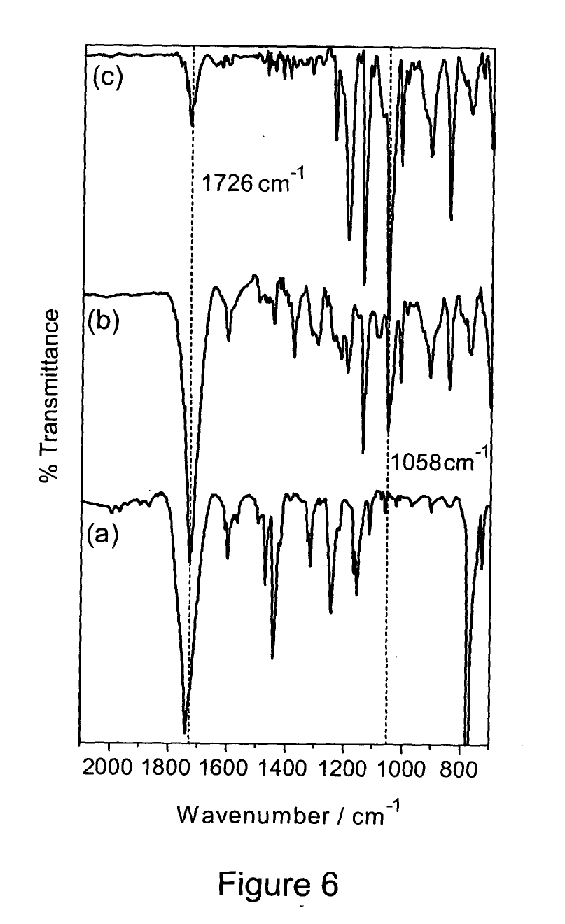

FIG. 6 shows infrared spectra of poly(glycidyl methacrylate) brushes grafted by ATRP onto continuous wave plasma deposited poly(vinylbenzyl chloride) ATRP initiator film, followed by derivatization with bromoacetic acid to yield macroinitiator layer. These were then employed for ATRP grafting of sodium styrene sulfonate side chains (bristles) for: (a) 0 min; (b) 30 min; and (c) 60 min;

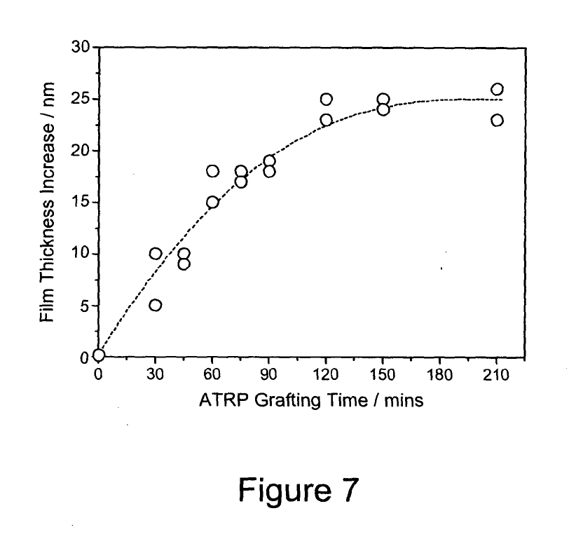

FIG. 7 shows change in polymer film thickness as a function of poly(sodium styrene sulfonate) ATRP grafting time for macroinitiator layers produced by bromoacetic acid derivatization of poly(glycidyl methacrylate) brushes grafted onto continuous wave plasma deposited poly(vinylbenzyl chloride) films;

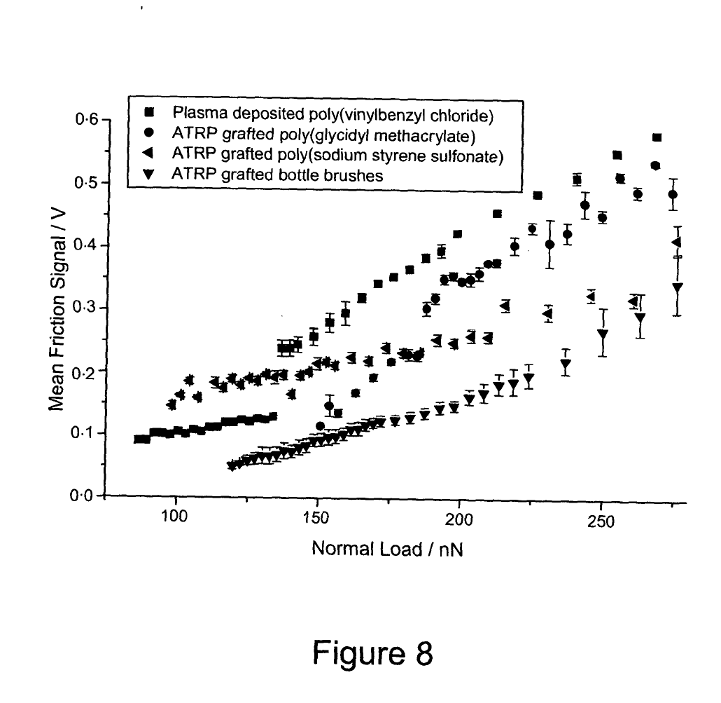

FIG. 8 shows friction signals obtained by lateral force microscopy as a function of normal load for: continuous wave plasma deposited poly(vinylbenzyl chloride) film; ATRP grafted poly(glycidyl methacrylate) on pulsed plasma deposited poly(vinylbenzyl chloride layer); ATRP grafted poly(sodium styrene sulfonate) brushes on pulsed plasma deposited poly(vinylbenzyl chloride layer); and ATRP grafted poly(glycidyl methacrylate)-graft-poly(sodium styrene sulfonate) bottle brushes on continuous wave plasma deposited poly(vinylbenzyl chloride layer); and

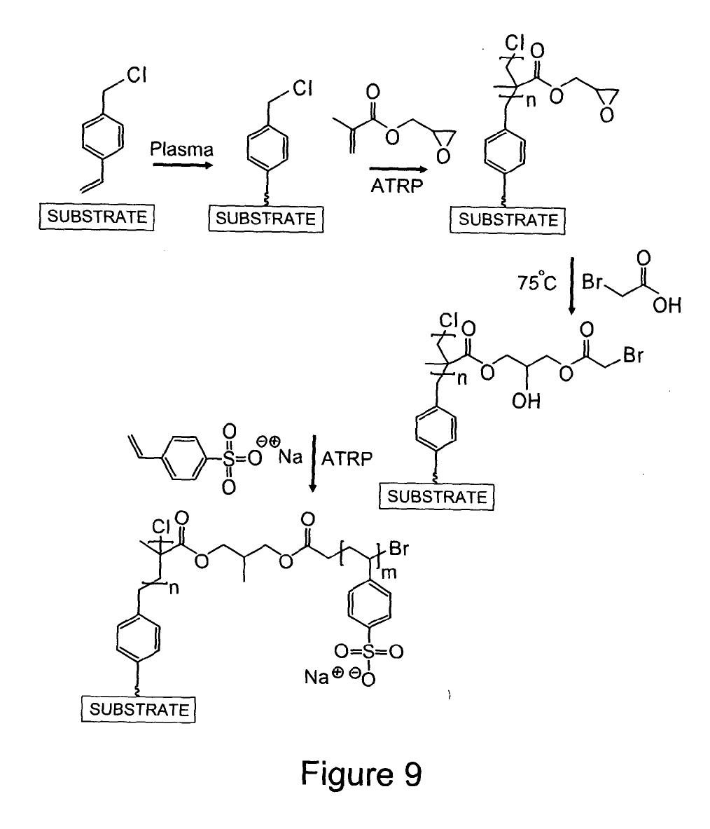

FIG. 9 is a scheme illustrating the main steps in formation the polymer brushes of the present invention.

### EXAMPLES

In the present invention, controlled ATRP surface grafting of poly(glycidyl methacrylate) brush layers is achieved using plasma deposited poly(vinylbenzyl chloride) nanofilms. These are then derivatized with bromoacetic acid to introduce ATRP initiation sites along the polymer brush backbone needed for the subsequent ATRP grafting of poly(sodium styrene sulfonate) side chains (bristles), as illustrated in FIG. 9. FIG. 9 is a scheme showing the main steps of the invention which comprise poly(glycidyl methacrylate) brushes grafted by ATRP onto plasma deposited poly(vinylbenzyl chloride) initiator films, followed by esterification of poly(glycidyl methacrylate) with bromoacetic acid to form tethered macroinitiation sites for the subsequent ATRP of poly(sodium styrene sulfonate) side chain ‘bristles’.

### Plasma Deposition of ATRP Initiator Films

Plasma depositions were performed inside a cylindrical glass reactor (5.5 cm diameter, 475 cm³ volume) located within a Faraday cage, and evacuated using a 30 L min⁻¹ rotary pump via a liquid nitrogen cold trap (base pressure less than 2×10⁻³ mbar and leak rate better than 6×10⁻⁹ mol per second). A copper coil wound around the reactor (4 mm diameter, 10 turns, located 10 cm away from the gas inlet) was connected to a 13.56 MHz radio frequency (RF) power supply via an L-C matching network. A signal generator was used to trigger the RF power supply. Prior to film deposition, the whole apparatus was thoroughly scrubbed using detergent and hot water, rinsed with propan-2-ol, and oven dried. Substrate preparation (glass cover slips or silicon wafer pieces) comprised successive sonication in propan-2-ol and cyclohexane for 15 min prior to insertion into the centre of the chamber. Further cleaning entailed running a 50 W continuous wave air plasma at 0.2 mbar for 30 min prior to film deposition. The vinylbenzyl chloride (+99.9%, Aldrich) precursor was loaded into a sealable glass tube, degassed via several freeze-pump thaw cycles, and then attached to the reactor. Monomer vapour was then allowed to purge the apparatus at a pressure of 0.2 mbar for 3 min prior to electrical discharge ignition. Pulsed plasma deposition was performed using a duty cycle on-period of 100 μs and a duty cycle off-period of 4 ms in conjunction with a peak power of 30 W. Continuous wave plasma deposition was carried out at 30 W. Upon plasma extinction, the precursor vapour continued to pass through the system for a further 3 min, and then the chamber was evacuated back down to base pressure.

### Bottle Brush Synthesis

For poly(glycidyl methacrylate) grafting, plasma deposited poly(vinylbenzyl chloride) initiator functionalised substrates were placed inside a sealable glass tube containing 5 mmol copper(I) bromide (+99.9%, Aldrich), 1 mmol copper(II) bromide (+99.9%, Aldrich), 12 mmol 2,2′-bipyridyl (+99.9%, Aldrich), 0.05 mol glycidyl methacrylate (+99.9%, Aldrich), and 4 mL N,N-dimethylformamide (+99.9%, Fisher), FIG. 9. The mixture was thoroughly degassed using freeze-pump-thaw cycles and then immersed into an oil bath maintained at 80° C. for a range of grafting times (1.0-3.5 hr). Final cleaning and removal of any physisorbed polymer was achieved by Soxhlet extraction using hot toluene for 16 hr.

Bromine-containing macroinitiator films were derived from surface tethered ATRP grafted poly(glycidyl methacrylate) brushes via esterification with bromoacetic acid (+99.9% Aldrich) vapour using a glass reactor placed inside a temperature controlled oven. Bromoacetic acid was loaded into a sealable glass tube, degassed via several freeze-pump-thaw cycles, and then attached to the reactor. The system was evacuated to 4×10⁻³ mbar and heated to 75° C. Next, bromoacetic acid vapour was purged through for 5 min, and then the reaction chamber isolated from the pump for 4 hr to allow reaction, followed by cooling to room temperature and evacuation to base pressure. In order to ensure complete removal of any unreacted bromoacetic acid, the substrates were thoroughly rinsed in high purity water and N,N-dimethylformamide (+99.9%, Fisher).

ATRP grafting of poly(sodium styrene sulfonate) was performed under aqueous conditions, due to the limited solubility of the monomer. A higher copper(II):copper(I) ratio was required in order to enhance halide capping efficiency, and thereby maintain control. Any trapped gases were removed from 1.0 g sodium styrene sulfonate (+99.9% Aldrich) dissolved in 3 mL of high purity water using a minimum of four freeze-pump-thaw cycles. The catalyst system consisted of 0.05 mmol copper(I) bromide, 0.04 mmol copper(II) bromide, and 0.18 mmol 2,2′-bipyridyl; these were added to the solution whilst it was frozen, together with the plasma deposited poly(vinylbenzyl chloride) initiator functionalised substrates. The reaction vessel was then immersed into an oil bath set to 50° C. for a predetermined grafting time. The substrate was then thoroughly rinsed in high purity water to remove any physisorbed polymer and allowed to dry in air. The charge fraction was 100% for grafted poly(sodium styrene sulfonate).

### Film Characterization

Film thicknesses were measured using a spectrophotometer (nkd-6000, Aquila Instruments Ltd.). Transmittance-reflectance curves (350-1000 nm wavelength range) were acquired for each sample and fitted to a Cauchy material model using a modified Levenberg-Marquardt algorithm.

Surface elemental compositions were obtained by X-ray photoelectron spectroscopy (XPS) using a VG ESCALAB II electron spectrometer equipped with a non-monochromated Mg Kα1,2 X-ray source (1253.6 eV) and a concentric hemispherical analyser. Photoemitted electrons were collected at a take-off angle of 30° from the substrate normal, with electron detection in the constant analyser energy mode (CAE, pass energy=20 eV). Experimentally determined instrument sensitivity factors were taken as C(1s):O(1s):Cl(2p):Br(3d):S(2p):Na(1s) equals 1.00:0.46:0.29:0.29:0.52:0.05.

Infrared spectra were acquired using a FTIR spectrometer (Perkin-Elmer Spectrum One) fitted with a liquid nitrogen cooled MCT detector operating at 4 cm¹ resolution across the 700-4000 cm′ range. The instrument included a variable angle reflection-absorption accessory (Specac)set to a grazing angle of 66° for silicon wafer substrates and adjusted for p-polarization.

### Nanotribology

Lateral force microscopy was performed in contact mode using a Nanoscope IV (Digital Instruments, Santa Barbara, Calif.) in combination with a fluid cell containing high purity water (BS 3978 Grade 1), and using a triangular Si₃N₄ contact mode SPM probe tip (Spring constant 0.24 N m⁻¹, Bruker Nano Inc.). To ensure consistent results, the same probe was used for all measurements. Normal loads were calculated using the nominal force constant provided by the manufacturer in conjunction with force-distance profiles, and varied by means of the contact mode set point. Friction data was collected over 1 μm×1 μm regions using a scan angle of 90° and a scan rate of 3 Hz. Sliding (dynamic) friction data was measured in Volts, and is reported as half of the difference between trace and retrace signals for the central 800 nm region of each scan line (thus excluding any scanning tip trace-retrace turnaround contributions attributable to static friction). This data is directly proportional to friction and was not converted to absolute friction force values because of the dependency upon which method is adopted to measure the lateral spring constant. Even if the method used to determine the lateral spring constant was completely reliable, friction coefficients are still very dependent on the measurement system employed and the various parameters involved (scan rate, contact area, counter surface, etc). Hence, for the purpose of the present study, the tribological experiments were undertaken by utilizing an internal reference, namely, the ATRP-grafted poly(NaStS) brushes tethered to a pulsed-plasma-deposited poly(VBC) layer. The 3 Hz scan rate of the AFM gives rise to a tip movement speed of 6 μm s⁻¹. Each reading was taken as the mean of 128 scan lines. The same tip was used for each comparative set of tribology measurements, and three different samples for each type of surface were analyzed. All of the scanning probe friction measurements were repeated several times and showed no variation (including at higher normal loads). This indicates that the tip shape was not modified to any significant extent.

### Results

### Plasma Deposition of Poly(Vinylbenzyl Chloride) ATRP Initiator Films

XPS analysis of the pulsed plasma deposited poly(vinylbenzyl chloride) films gave elemental compositions corresponding to the expected theoretical values based on the vinylbenzyl chloride monomer, thus indicating good structural retention of the benzyl chloride functionality, Table 1. In addition, the absence of any Si(2p) XPS signal confirmed pinhole free coverage of the underlying silicon wafer substrate. Further evidence for the structural integrity of pulsed plasma deposited poly(vinylbenzyl chloride) films was obtained by infrared spectroscopy, where the fingerprint features closely match those measured for the monomer, FIG. 1. These include halide functionality (required for subsequent ATRP initiation) at 1263 cm⁻¹ (CH₂ wag mode for CH₂—Cl), and para-substituted benzene ring stretches at 1495 cm⁻¹ and 1603 cm⁻¹. In addition, the observed loss of the vinyl double bond stretch at 1629 cm⁻¹ is consistent with polymerization. In the case of continuous wave plasma deposited poly(vinylbenzyl chloride) films greater structural disruption was evident by the slightly lower chlorine content detected by XPS, and much weaker infrared absorbances for the characteristic benzyl chloride functionalities, Table 1 and FIG. 1.

TABLE 1
XPS elemental compositions of plasma deposited
poly(vinylbenzyl chloride) films, and ATRP grafted polymer
brushes and bottle brushes.

| | | XPS Elemental Composition | | | | | |
|---|---|---|---|---|---|---|---|
| Surface | | C % | O % | Cl % | S % | Br % | Na % |
| Plasma deposited | Theoretical | 90 | 0 | 10 | 0 | 0 | 0 |
| poly(vinylbenzyl | Pulsed | 90 | 0 | 10 | 0 | 0 | 0 |
| chloride) | Continuous | 91 | 0 | 9 | 0 | 0 | 0 |
| | Wave | | | | | | |
| ATRP grafted | Theoretical | 70 | 30 | 0 | 0 | 0 | 0 |
| poly(glycidyl | Pulsed | 69 | 31 | 0 | 0 | 0 | 0 |
| methacrylate) | Continuous | 72 | 28 | 0 | 0 | 0 | 0 |
| | Wave | | | | | | |
| ATRP grafted | Theoretical | 61 | 23 | 0 | 8 | 0 | 8 |
| poly(sodium | Pulsed | 68 | 24 | 0 | 7 | 0 | 2 |
| styrene | | | | | | | |
| sulfonate) | | | | | | | |
| ATRP grafted | Theoretical | 60 | 33 | 0 | 0 | 7 | 0 |
| poly(glycidyl | Pulsed | 70 | 25 | 0 | 0 | 4 | 0 |
| methacrylate) | Continuous | 70 | 26 | 0 | 0 | 4 | 0 |
| reacted with | Wave | | | | | | |
| bromoacetic acid | | | | | | | |
| ATRP grafted | Pulsed | 85 | 13 | 0 | 2 | 0 | 0 |
| poly(glycidyl | Continuous | 73 | 23 | 0 | 3 | 0 | 0 |
| methacrylate)- | Wave | | | | | | |
| poly (sodium | | | | | | | |
| styrene | | | | | | | |
| sulfonate) bottle | | | | | | | |
| brushes | | | | | | | |

### ATRP Grafting of Glycidyl Methacrylate and Sodium Styrene Sulfonate

ATRP grafted poly(glycidyl methacrylate) brushes grown from the structurally well defined pulsed plasma deposited poly(vinylbenzyl chloride) ATRP initiator films yielded XPS elemental compositions in close agreement to those calculated for poly(glycidyl methacrylate), Table 1 and FIG. 9. Absence of Cl(2p) XPS signal from the underlying initiator film verified complete coverage by polymer brushes. Characteristic infrared absorbances measured for both glycidyl methacrylate monomer and ATRP grafted poly(glycidyl methacrylate) layers include the ester C═O stretch at 1726 cm⁻¹ (1714 cm⁻¹ for the monomer, due to conjugation with the vinyl group) and the C—O stretch at 1152 cm⁻¹, FIG. 2. Loss of the monomer vinyl absorptions at 1637 cm (C═C stretch) and 941 cm⁻¹ (vinyl CH₂ wag) provided further evidence for ATRP having taken place. The controlled nature of surface initiated ATRP was confirmed by monitoring the linear increase of poly(glycidyl methacrylate) film thickness versus grafting time, yielding a deposition rate of 76±6 nm hr⁻¹, FIG. 3. The ATRP film growth rate was found to be independent of pulsed plasma deposited poly(vinylbenzyl chloride) film thickness, thereby confirming that ATRP initiation must be confined to the plasma polymer surface. Furthermore, omission of the catalytic copper species from the reaction mixture under otherwise identical conditions resulted in no detectable poly(glycidyl methacrylate) grafting after 4 hr, thus eliminating the possibility of auto polymerization as an alternative explanation for the reported observations.

The XPS elemental compositions and characteristic infrared absorbances of ATRP grafted poly(glycidyl methacrylate) onto continuous wave plasma deposited poly(vinylbenzyl chloride) films were found to be consistent with those measured for the corresponding pulsed plasma deposited poly(vinylbenzyl chloride) ATRP initiator films, Table 1. However, polymer brush film thicknesses following 2 hours ATRP grafting were 26±5 nm and 137±5 nm respectively, which is consistent with the poor structural integrity of continuous wave versus pulsed plasma deposited layers.

Similarly, XPS analysis of ATRP grafted poly(sodium styrene sulfonate) grown onto pulsed plasma poly(vinylbenzyl chloride) initiator films yielded elemental compositions in close agreement with calculated theoretical values, Table 1. Absence of Cl(2p) signal indicated complete coverage of the substrate. The amount of sodium counter ions measured was found to be much lower than the quantity of sulphur and can be attributed to protonation of the sulfonate groups to form the acid. ATRP graft polymer brush thickness versus time displayed a linear growth rate of 31±2 nm hr⁻¹, FIG. 4. Grafting times exceeding 90 min culminated in a loss of control, which can be attributed to the oxidative breakdown of catalytic species (something which is commonly found for aqueous phase ATRP). Infrared spectroscopy of the ATRP grafted poly(sodium styrene sulfonate) layers revealed fingerprint features matching those associated with the monomer, FIG. 5. These include absorbances at 1140 cm⁻¹, 1188 cm⁻¹ and 1234 cm⁻¹ (antisymmetric SO₂ stretches) and 1058 cm⁻¹ (symmetric SO₂ stretch). The monomer vinyl C═C stretch absorption at 1638 cm⁻¹ disappeared following ATRP polymerization.

### Bottle Brush Fabrication

Poly(glycidyl methacrylate) brushes grafted from plasma deposited poly(vinylbenzyl chloride) layers were exposed to bromoacetic acid in order to introduce ATRP macroinitiation sites along the poly(glycidyl methacrylate) brush backbone, FIG. 9. Bromine incorporation was verified by XPS elemental analysis, Table 1. Additional evidence for the reaction between pendant epoxide groups of poly(glycidyl methacrylate) and bromoacetic acid was found by infrared spectroscopy, FIG. 2. Absorbances associated with the epoxide functionality at 1254 cm⁻¹ (epoxide ring breathing), 906 cm⁻¹ (antisymmetric ring deformation) and 841 cm⁻¹ (symmetrical ring deformation) were all attenuated and an additional absorbance at 1245 cm⁻¹ attributed to the CH₂ wag on CH₂—Br was evident. Furthermore, broadening of the ester C═O stretch absorption at 1726 cm⁻¹ confirmed the presence of expected multiple ester environments in the resultant macroinitiator film.

In order to provide adequate space for the growth of side chain ‘bristles’, the optimum macroinitiator graft density was achieved by initiating ATRP of poly(glycidyl methacrylate) from continuous wave plasma deposited poly(vinylbenzyl chloride), and then exposing the polymer brushes to bromoacetic acid. ATRP grafting of poly(sodium styrene sulfonate) side chains from these macroinitiator layers was confirmed by infrared spectroscopy, FIG. 6 and FIG. 9. The relative intensity of the ester carbonyl stretch at 1726 cm⁻¹ from the brush backbone compared to the symmetric SO₂ stretch at 1058 cm⁻¹ was reduced with increasing poly(sodium styrene sulfonate) grafting time, indicating the growth of poly(sodium styrene sulfonate) bristles. Further confirmation was obtained by monitoring the increase of film thickness versus ATRP grafting time of poly(sodium styrene sulfonate) side chains, FIG. 7. In order to prove that ATRP grafting of poly(sodium styrene sulfonate) side chains from the derivatized poly(glycidyl methacrylate) brushes has taken place, corresponding ATRP grafted poly(glycidyl methacrylate) brushes were reacted with acetic acid vapour as a substitute for bromoacetic acid (same derivatization chemistry but absent halogen initiator atom). Subsequent exposure to ATRP conditions for sodium styrene sulfonate lasting 120 min resulted in no measurable increase in film thickness, thus eliminating the alternative explanation that reactivation of poly(glycidyl methacrylate) chain ends would lead to formation of block copolymers and account for the observed changes in film thickness and infrared spectra.

Further control experiments involved macroinitiators consisting of bromoacetic acid derivatized poly(glycidyl methacrylate) brushes grafted onto pulsed plasma deposited poly(vinylbenzyl chloride) initiator films, which yielded identical bromine content by XPS analysis, Table 1. However, ATRP grafting of poly(sodium styrene sulfonate) for 120 min resulted in an attenuated increase in film thickness (5 nm vs 24 nm) and a lower amount of sulphur, when compared to macroinitiators based on continuous wave plasma deposited poly(vinylbenzyl chloride) nanofilms, Table 1.

### Nanotribology

Friction between a sliding SPM probe tip and the polymer brush layers was measured in an aqueous environment as a function of normal load, FIG. 8. Friction data and height images were recorded simultaneously, and homogeneous 1 μm×1 μm regions (rms roughness <2 nm) were selected for data collection. The plasma deposited poly(vinylbenzyl chloride) layers exhibit a sharp rise in friction around 130 nN normal load; which is indicative of polymer chain displacement and wear. Furthermore, the bottle brush layers consistently gave lower friction readings compared to poly(glycidyl methacrylate) and poly(sodium styrene sulfonate) brush layers (grafted from the pulsed plasma deposited poly(vinylbenzyl chloride) initiator film). This enhancement can be attributed to steric repulsion and water solvation of the bottle brushes leading to a resistance towards penetration (and hence improved lubrication). These tribological experiments were devised in such a manner so as to utilize an internal reference, namely, the ATRP-grafted poly(NaStS) brushes on the pulsed-plasma-deposited poly (VBC) layer. Even if there is minor contribution due to negatively charged Coulombic repulsion arising from the lowering of pH by the dissolution of atmospheric CO₂ into the pure water medium, this factor will be expected to be present for both the surface ATRP-grafted poly(NaStS) brushes and surface ATRP-grafted poly(GMA)-graft-poly(NaStS) bottle brushes. By taking this possibility into consideration, the tribology measurements show that the graft-poly(NaStS) bristles contained in the bottle brushes display lower friction than do their linear-surface-grafted poly(NaStS) brush counterparts.

In the case of polymers sliding against solid surfaces, it has been proposed that the variation in friction with shear rate is due to a transition from coil to stretched conformations and therefore it is expected that friction is required for densely grafted polymer brush layers (which already exist in extended conformations under good solvent conditions) to exhibit a low dependence on shear rate. Surface force balance experiments measuring the sliding friction between polymer brush layers found only a weak velocity dependence, and this was also the case for scanning probe friction studies comparing physisorbed versus surface-immobilized polyelectrolytes. Hence, given that the present bottle brushes are covalently tethered to the substrate, any variations in friction due to shear rate can be expected to be relatively small.

### Discussion

Pulsed plasma deposited poly(vinylbenzyl chloride) has previously been shown to be a highly effective ATRP initiator. This can be attributed to the stabilized benzyl radicals which allow chloride abstraction from the benzyl chloride surface functionality to easily occur during ATRP initiation (since benzyl radicals are stabilised by the aromatic ring). Therefore, the structural integrity of benzyl chloride groups within the plasma deposited film governs the effective surface density of ATRP initiation sites. This is evident for the densely crowded poly(glycidyl methacrylate) and poly(sodium styrene sulfonate) brush layers produced by ATRP for the structurally well defined pulsed plasma deposited poly(vinylbenzyl chloride) films. These grow in a controlled fashion with polymer brush thickness increasing linearly, i.e. steric crowding drives chains to adopt extended conformations, FIGS. 3 and 4. In order to lower the surface density of grafted polymer brushes so as to provide space for side chain (bristle) growth, continuous wave plasma deposited poly(vinylbenzyl chloride) films were shown by infrared and XPS analysis to contain a lower density of intact benzyl chloride initiator groups due to less structural integrity. This difference in density of benzyl chloride initiation sites between continuous wave and pulsed plasma deposited poly(vinylbenzyl chloride) can be explained on the basis of their respective film growth mechanisms. During pulsed plasma deposition, electric discharge modulation comprises a short plasma duty cycle on-period (microseconds) to generate active sites in the gas phase as well as at the growing film surface via VUV irradiation, ion and electron bombardment, followed by conventional carbon-carbon double bond polymerization processes proceeding throughout each accompanying extended pulse off-period (milliseconds) in the absence of any UV, ion, or electron-induced damage to the growing film. Such conventional polymerization pathways are strongly perturbed during continuous wave plasma conditions, where the multitude of reactions for radicals, ions and excited species contained within the electrical discharge play a greater role leading to structural disruption. Furthermore, the average power supplied to the vinylbenzyl chloride precursor vapour during continuous wave plasma discharge (30 W) was significantly greater in comparison to pulsed plasma deposition (0.7 W).

As a consequence, the thickness of the ATRP grafted poly(glycidyl methacrylate) layers measured for the continuous wave deposited poly(vinylbenzyl chloride) films is considerably lowered in comparison to those prepared using pulsed plasma conditions. Given the identical ATRP conditions, the grafted poly(glycidyl methacrylate) brushes can be considered to be comparable in length between the pulsed and continuous wave plasma deposited initiator nanofilms, and therefore the lower film thickness in the latter case can be attributed to the collapsed conformation of poly(glycidyl methacrylate) chains, stemming from the lower surface initiation site density.

Subsequent exposure to bromoacetic acid of the aforementioned surface tethered poly(glycidyl methacrylate) brushes yields well-defined surface immobilised macroinitiator species. This approach follows previously reported solution phase macroinitiator brush syntheses as precursors for bottle brushes based on the esterification of pendant hydroxyl groups of poly(hydroxyethyl methacrylate) backbone polymers. In the present study, the epoxide functionalities contained within poly(glycidyl methacrylate) brushes provide a more reactive handle for esterification with bromoacetic acid vapour, FIG. 9, Table 1, and FIG. 2. This overall ATRP approach is key to the formation of well-defined macroinitiator brushes and the subsequent synthesis of the bottle brush bristles (in contrast, the lack of control associated with conventional polymerization initiators leads to ill defined macroinitiator brushes and side chains).

Characterisation of surface immobilised bottle brush polymers is challenging. One approach is to analyse polymers formed in solution alongside the sample via the introduction of sacrificial initiator species, however this fails to address the issues unique to surface tethering such as steric crowding. In the present study, the sulfonate groups of poly(sodium styrene sulfonate) side chains (bristles), provide strong characteristic infrared absorbances which follow the increase in film thickness, FIGS. 6 and 7. The absence of both these trends for when initiator bromide groups were not present along the poly(glycidyl methacrylate) brush backbone (via esterification with acetic acid instead of bromoacetic acid, FIG. 9) verifies that poly(sodium styrene sulfonate) chains (bristles) only form when initiation sites are present along the polymer brush.

Given the inherent control afforded over macromolecular architecture, surface tethered well-defined bottle brush polymers prepared by ATRP are an attractive prospect for the development of novel surface properties, such as lubricity, in particular nanolubricity. Tailoring of both the backbone and bristle segments can be achieved using the ‘grafting from’ approach; furthermore the surface density of backbone grafts can also be independently controlled using plasmachemical deposition of initiation sites in order to allow predetermined side chain (bristle) growth.

In comparison to neutral hydrophilic brushes, polyelectrolyte brushes exhibit a high osmotic pressure (charge repulsion) in aqueous environments, which enhances their lubricity. Surface-grafter polyelectrolyte brushes are also reported to display such behavior. In the present study, the surface-tethered bottle brushes investigated are found to display even lower friction when compared to their constituent linear polymer brush counterparts. This behaviour can be attributed to the former being more compact (and hydrated) as described in earlier reports relating to enhanced lubrication by similar hydrophilic bottle brush polymers that had been physisorbed onto substrates and also low asymmetric friction measurements observed for polyelectrolyte brushes. The dry heights of the poly(sodium styrene sulfonate) brush and bottle brush layers used for the scanning probe fiction measurements were both kept the same (50 nm, FIG. 8). XPS analysis shows a smaller amount of sulfur at the surface for the poly(sodium styrene sulfonate) bottle brush compared to that for the brush layers (3±1 vs 7±1%, respectively, Table 1), which indicates a lower counterion density, thereby negating the idea that the reduced friction is due to an increased number of counterions per unit area. Therefore, the decreased friction is related to the molecular geometry (linear vs bottle brush). Grafting side chains from the polymer backbone to form bottlebrush structures can be expected to increase the macromolecular rigidity.

The key merits of the present approach revolve around the substrate-independent covalent anchoring of the bottle brushes to the surface which offers scope for far more widespread applicability than their physisorbed counterparts. Potential applications of such surface-tethered bottle brushes could include actuators, sensors, building blocks for nanostructures, templates for producing metallic nanowires, and mimicking biomolecules possessing bottle brush architectures for performing biological lubrication (such as proteoglycans and epithelial-tethered mucins).

### CONCLUSIONS

Surface-tethered polymer bottle brushes have been produced by ATRP from plasmachemical-deposited initiator films. Variation in plasma deposition parameters enables the surface density of ATRP initiation sites to be tailored, which in turn allows the spacing of macroinitiators to be controlled, so as to allow growth of polymer brush side chains (bristles). Lateral force scanning probe microscopy has shown that poly(glycidyl methacrylate)-graft-poly(sodium styrene sulfonate) bottle brush-decorated surfaces give rise to an enhancement in lubrication.

1. A method of creating a polymer brush bearing covalently bound polymeric side chains, comprising the steps of:
(a) deposition, onto a substrate, of a halogen containing 5 initiator film or a precursor which is derivatized into a halogen containing initiator film;
(b) surface ATRP growth, from the halogen containing initiator film formed in step (a), of a polymeric brush backbone incorporating side groups;
(c) growth, from the polymeric brush backbone formed in step (b), of polymeric side chains on the polymeric brush backbone, to form a polymer brush in which the polymeric side chains constitute the bristles of the brush.

2. The method according to claim 1, wherein the side groups on the polymeric brush backbone formed in step (b) comprise further initiation sites for polymer growth.

3. The method according to claim 1, wherein in step (c), the growth of polymeric side chains on the polymeric brush backbone occurs via one or more derivatization steps in which the side groups on the polymeric brush backbone are derivatized to form further initiation sites for polymer growth.

4. The method according to claim 1, wherein the halogen containing initiator film is formed by polymerization of a halogen containing molecule, such as a vinylbenzyl halide, for example vinylbenzyl chloride.

5. The method according to claim 1, wherein deposition of the halogen containing initiator film or the precursor is by a technique selected from the group of plasma polymerization, thermal chemical vapour deposition, initiated chemical vapour deposition (iCVD), photodeposition, ion-assisted deposition, electron beam polymerization, gamma-ray polymerization, target sputtering, and any combination thereof.

6. The method according to claim 5, wherein the halogen containing initiator film is deposited by plasma polymerization.

7. The method according to claim 1, wherein in step (b), the monomer used for the surface ATRP growth of the polymeric brush backbone is selected from the group of styrenes, acrylates, methacrylates, and acrylonitrile.

8. The method according to claim 7, wherein the monomer comprises glycidyl methacrylate.

9. The method according to claim 1, wherein in step (c), the growth of polymeric side chains on the polymeric brush backbone is ATRP growth.

10. The method according to claim 3, wherein in step (c), the side groups on the polymeric brush backbone are derivatized to form ATRP initiation sites for ATRP growth of the polymeric side chains.

11. The method according to claim 10, wherein the side groups on the polymeric brush backbone are derivatized to form halogenated ATRP initiation sites, for example by reaction with bromoacetic acid.

12. The method according to claim 1, wherein in step (c), the monomer used for the growth of the polymeric side chains is selected from the group of styrenes, acrylates, methacrylates, and acrylonitrile.

13. The method according to claim 12, wherein the monomer comprises sodium styrene sulfonate.

14. A polymer brush formed by the method of claim 1.

15. Use of a polymer brush according to claim 14 as a lubricant.
